(19) United States
(12) Patent Application Publication
(10) Pub. No.: US 2005/0002784 A1
(43) Pub. Date: Jan. 6, 2005

(54) Fan with guiding rib in vent

(75) Inventors: Nien-Lun Li, Hsin-Chuang City (TW); Fu-Yin Wang, Hsin-Chuang City (JP); Yu-Hsun Chou, Hsin-Chuang City (TW)

Correspondence Address: TROXELL LAW OFFICE PLLC, SUITE 1404, 5205 LEESBURG PIKE, FALLS CHURCH, VA, 22041, US

(73) Assignee: Datech Technology Co., Ltd.

(21) Appl. No.: 10/647,391

(22) Filed: Aug. 26, 2003

(30) Foreign Application Priority Data
Jul. 2, 2003 (TW) 092212198

(51) Int. Cl. F03B 1/00

(52) U.S. Cl. 415/220

(57) ABSTRACT

A fan with guiding ribs in a vent comprises a frame body and a supporting part. The supporting part comprises a pivot connecting fan blade and guiding ribs with outside extension, wherein by means of the guiding ribs, the supporting part is disposed on the inner end surface of the frame body and the profile of guiding ribs is to have an inclined plane that gradually shrink from the end surface to fan blades. By the above structure, complicated components in the prior art can be simplified and the resistance generated by the guiding ribs can be reduced as well. Furthermore, the air flow blown from fan blades is guided to further increase pressure output by the fan.

### REFERENCE CITED

1. U.S. Pat. No. 6,244,818 B1

### FIELD OF THE INVENTION

The present invention relates to a fan with guiding ribs in a vent. More particularly, by the structure, complicated components in the prior art can be simplified and the resistance generated by the guiding ribs can be reduced as well. Furthermore, the air flow blown from fan blades is guided to further increase pressure output by the fan.

### BACKGROUND OF THE INVENTION

A conventional fan comprises a vent; a supporting part for supporting fan blades to rotate thereof. There are guiding ribs with outside extension from the circumference of the supporting part, connecting to the fan frame body. The guiding rib is in a stick shape for supporting the supporting part to mount on the central portion of the vent. However, since being in a stick shape, when the fan blade blows, the guiding ribs will generate air flow (air pressure) with air resistance, which affects the air pressure of the fan. Moreover, the cyclone is generated due to interference of the stick-shaped guiding ribs after the air flow generated by the fan blades passes through the guiding ribs, therefore resulting in air pressure damages and efficiency reduction of the fan. Accordingly, some manufactures develop a fan guard structure for additional supercharging function, shown in U.S. Pat. No. 6,244,818 B1. The fan guard is for supporting rotor blades and thus enhances the air pressure of the rotor blades as rotating, which comprising:
a main frame;
a supporting part for supporting rotor blades for rotating thereof; and
a guiding apparatus, connecting between the main frame and the supporting part, for increasing the air pressure as rotor blades rotate;

The guiding apparatus is arranged downstream of the rotor blades, and has a shape substantially identical to that of the rotor blades and an arrangement relative to the rotor blades allowing any one of the guard blades and any one of the rotor blades to constitute an approximate C configuration in a cross-sectional view at a moment that a leading point of the guard blade aligned with a trailing point of the rotor blade in an axial direction, and thereby transforming a tangential velocity of the air outflow from into a static pressure to supercharge the fan.

Although the fan guard structure for additional supercharging function provided in the above U.S. patent may transform a tangential velocity of the air outflow blown from the rotor blades into a static pressure to supercharge the fan. However, since the guiding rib is replaced by others with a shape similar to the rotor blades (there are two blades on the fan, one is rotor blade which is rotatable; the other one is static blade mounted on the frame body), the structure of the guiding apparatus turns out to be very complicated.

### SUMMARY OF THE INVENTION

The main objective of the present invention is to reduce the resistance generated by guiding ribs and to guide the air flow blown from fan blades to further increase pressure output by the fan.

Another objective of the present invention is to simplify complicated components for a fan in the prior art for simpler construction with same functions.

To achieve the above objectives, the present invention provides a fan with guiding ribs in vent, which comprises:
a frame body having a hole;
a supporting part composed of a pivot and guiding ribs with outside extension, wherein the pivot connects a fan blade, by means-of the guiding ribs, the supporting part is disposed on the inner end surface of the hole, the profile of the guiding rib is to have an inclined plane that gradually shrink from the end surface to the fan blade.

By the above structure, complicated components in the prior art can be simplified, and the resistance generated by the guiding ribs can be reduced as well. Furthermore, the air flow blown from fan blades is guided to further increase pressure output by the fan.

### BRIEF DESCRIPTION OF THE DRAWINGS

The present invention will be better understood from the following detailed description of preferred embodiments of the invention, taken in conjunction with the accompanying drawings, in which

FIG. 1 is a diagram showing an outward appearance of the present invention;

FIG. 2 is a diagram showing a view in separation configuration of the present invention;

FIG. 3 is a cross-section diagram of the present invention;

FIG. 4 is a diagram showing a view in operation configuration of the present invention;

FIG. 5 is a cross-section diagram showing a view of air flow passing through a guiding rib of the present invention; and

FIG. 6 is a chart showing a view in a testing configuration of the present invention.

### DETAIL DESCRIPTION OF THE INVENTION

The following descriptions of the preferred embodiments are provided to understand the features and the structures of the present invention.

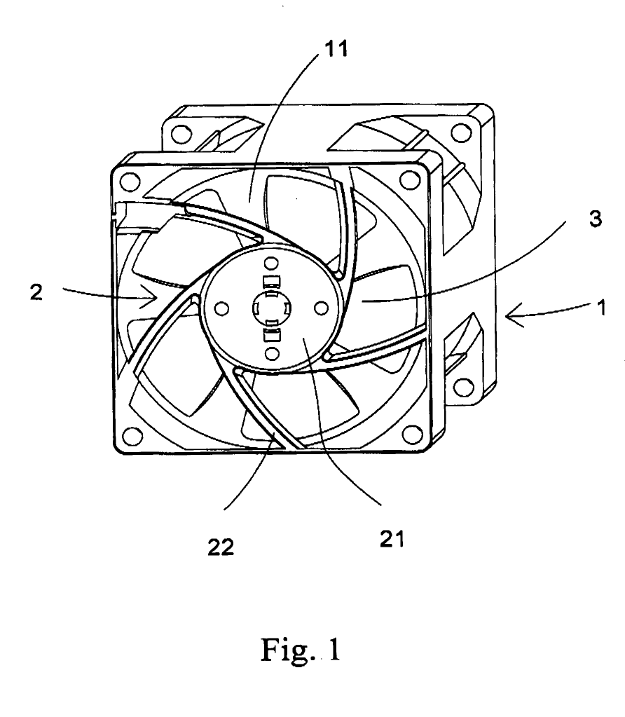

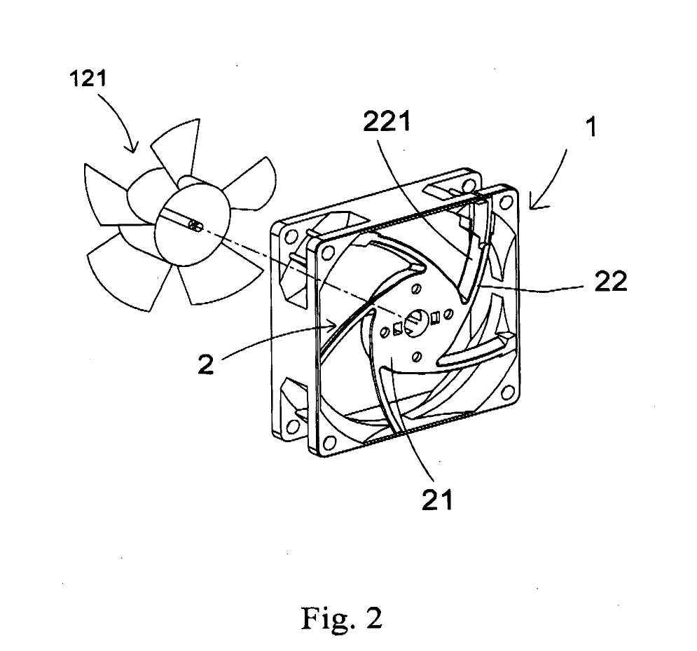

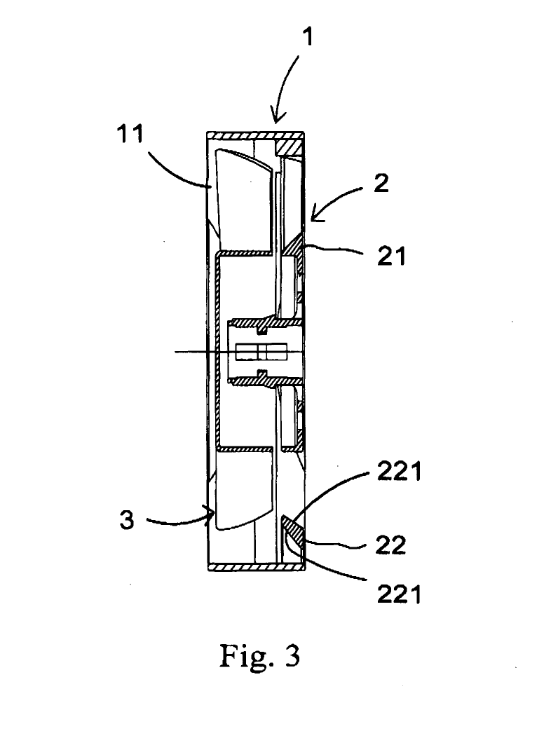

FIG. 1, FIG. 2, and FIG. 3 are respectively a diagram showing an outward appearance of the present invention, a diagram showing a view in separation configuration of the present invention, and a cross-section diagram of the present invention. As shown in the diagrams, the present invention provides a fan with guide ribs in a vent, comprising a frame body 1 and a supporting part 2. By that, complicated components in the prior art can be simplified, and the resistance generated by the guiding ribs can be reduced as well. Furthermore, the air flow blown from fan blades is guided to further increase pressure output by the fan.

The frame body 1 mentioned above has a hole 11 in its central portion;

The support part 2 is composed of a pivot 21 and guiding ribs 22 with outside extension from the pivot 21. Wherein, the pivot 21 connects a fan blade 3. By means of the guiding ribs 22, the supporting part 2 is disposed on the inner end surface of the hole 11 of the frame body 1. The profile of the guiding rib 22 is to have an inclined plane 221 that gradually shrink from the end surface to the fan blade3. The guiding ribs 22 are in a curved shape in response to a direction of air flow blown from the fan blade 3. Therefore, a novel fan with guiding ribs in a vent is provided.

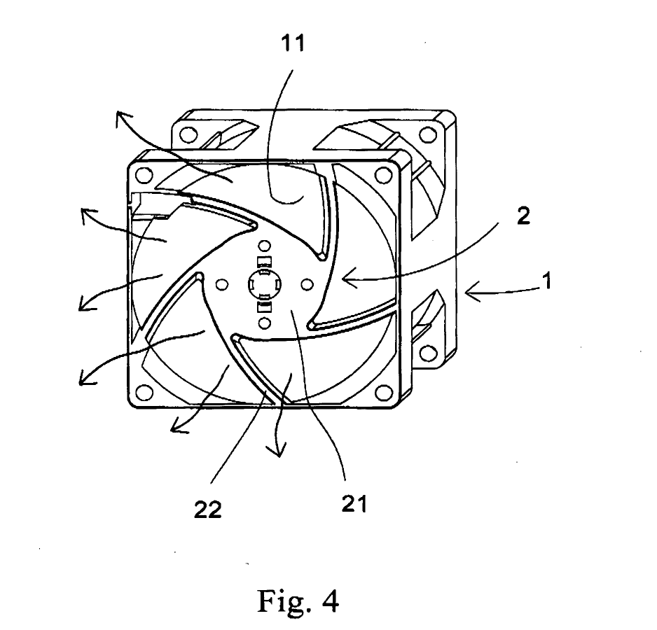

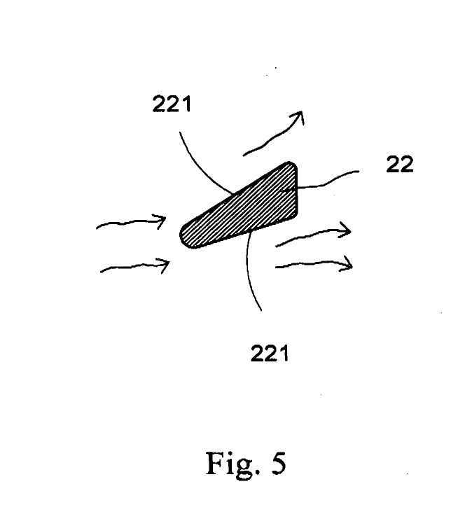

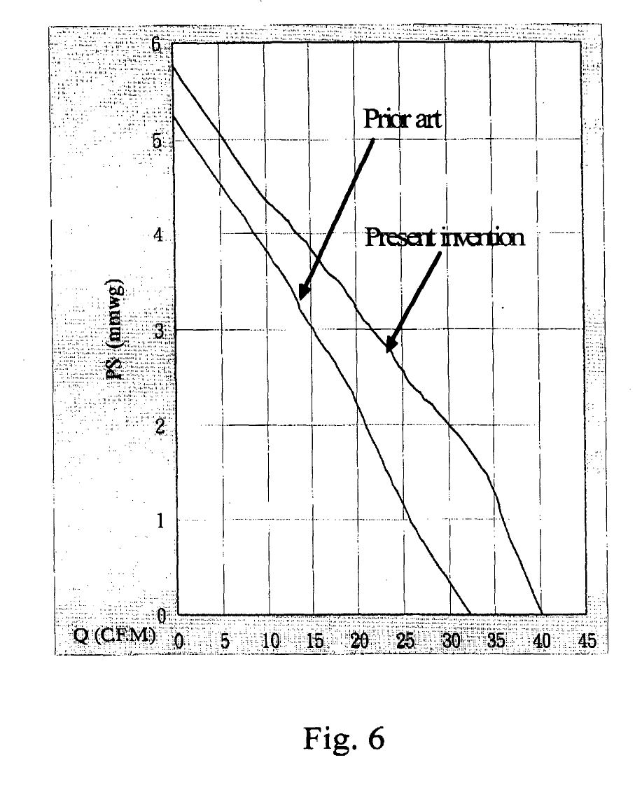

FIG. 4, FIG. 5, and FIG. 6 are respectively a diagram showing a view in operation configuration of the present invention, a cross-section diagram showing a view of air flow passing through a guiding rib of the present invention, and a chart showing a view in a testing configuration of the present invention. As shown in the diagrams: while using the fan, an external power is provided to the fan (not shown), such that air flow will blow from the fan blade 3 of the fan as it rotates. When the fan blade 3 blows, the air flow will be in the direction toward the supporting part 2. For the time being, since the supporting part 2 is disposed on the inner end surface of the hole 11 of the frame body 1, the guiding ribs 22 are between the pivot 21 and the frame body 1 and the guiding rib 22 has an inclined plane 221 that gradually shrink from the end surface to the fan blade3. By means of the guiding ribs 22, the air flow is guided from the shrink end of the guiding ribs 22 to the inclined plane 221 of the guiding ribs 22 and then is exhaled. Furthermore, since the guiding ribs 22 are in a curved shape in response to a direction of air flow blown from the fan blade 3. Thus, the air flow blown from the fan blade 3 will shrink from the corresponding position of the fan blade 3. By the curved guiding ribs 22 in response to the direction of the air flow blown from the rotating fan blade 3, air pressure generated by the guiding ribs is reduced and the air flow blown from the fan blade is guided to further increase the air pressure output from the fan.

FIG. 6 is a chart showing a view in a testing configuration which compares the present invention and the stick-shaped guiding ribs of the prior art. Wherein, both the fan of the present invention and that of the prior art are of 4500 RPM. Under the identical condition and the same air flow, from the chart, the fan of the present invention can provide larger air pressure than that of prior art with stick-shaped guiding ribs.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

1. A fan with a guiding rib in a vent, comprising:
a frame body having a hole;
a supporting part composed of a pivot and guiding ribs with outside extension, wherein said pivot connects a fan blade, by means of said guiding ribs, said supporting part is disposed on the inner end surface of said hole, the profile of said guiding rib is to have an inclined plane that gradually shrink from the end surface to said fan blade.

2. The fan with a guiding rib in a vent of claim 1, wherein said guiding ribs are in a curved shape in response to a direction of air flow blown from said fan blade.
